(19) United States
(12) Patent Application Publication
(10) Pub. No.: US 2024/0132667 A1
(43) Pub. Date: Apr. 25, 2024

(54) POLYAMIDE FOAM MOLDED BODY AND METHOD FOR MANUFACTURING THE SAME

(71) Applicant: National Taipei University of Technology, Taipei (TW)

(72) Inventors: Yi-Huan Lee, Taipei (TW); Chia-Hsing Lin, Taipei (TW); Chia-Wei Lee, Taipei (TW)

(21) Appl. No.: 18/462,756

(22) Filed: Sep. 7, 2023

(30) Foreign Application Priority Data
Oct. 13, 2022 (TW) 111138922

(51) Int. Cl. C08G 69/42; C08G 69/36; C08J 9/12

(52) U.S. Cl. CPC C08G 69/42; C08G 69/36; C08J 9/122; B29C 44/3442; C08J 2203/06; C08J 2203/08; C08J 2477/06

(57) ABSTRACT

Provided is a polyamide foam molded body and method for manufacturing the same. The method includes performing polymerization with a monomer composition to form a polyamide terpolymer; mixing a supercritical carbon dioxide foaming agent and the polyamide terpolymer under a pressure to form a mixture; and releasing the pressure of the mixture to foam the polyamide terpolymer for forming the polyamide foam molded body. The monomer composition comprises 50 to 70 mole % of a caprolactam, 4 to 15 mole % of a polyetheramine, 4 to 15 mole % of a dicarboxylic acid and 15 to 30 mole % of a Nylon salt. The polyamide terpolymer includes a hard segment formed by the caprolactam, the dicarboxylic acid and the Nylon salt and a soft segment formed by the polyetheramine. The polyamide foam molded body exhibits excellent properties and is environmental-friendly.

### CROSS-REFERENCE TO RELATED PATENT APPLICATION

This application claims the benefit under 35 U.S.C. §119 of Taiwan Patent Application Ser. No. 111138922 filed on Oct. 13, 2022, which is incorporated herein by reference in its entirety.

Some references, which may include patents, patent applications, known arts, and various publications, may be cited and discussed in the description of this disclosure. The citation and/or discussion of such references is provided merely to clarify the description of the present disclosure and this provision should not be construed to mean that any such references are “prior arts” to the disclosure described herein. All references cited and discussed in this specification are incorporated herein by reference in their entirety and to the same extent as if each reference was individually incorporated by reference.

### FIELD OF THE DISCLOSURE

The present disclosure relates to a polyamide foam molded body and a method for manufacturing the same, and more particularly to a polyamide foam molded body and a method for manufacturing the same using a polyamide terpolymer as a material.

### BACKGROUND

Synthetic polymers consisted of polyamides are collectively called as Nylon materials. Based on the excellent mechanical property, barrier property, high and low temperature resistant property, electrical property, chemical resistant property, wear resistant property, weather resistant property and size stability, Nylon materials are widely used in the industry. Specifically, using Nylon material for forming foam molded product may provide the product good rigidity, cushioning property, heat insulation property and sound insulation property, etc.

Based on its unique properties, polyamide material may be used to manufacture artificial fabrics and thus may be used in shoe-making industry, for example, as the material for the surface fabric and shoelaces for shoes. Therefore, if the foam molded product of polyamide may be used as the material for manufacturing other components of a shoe product, for example, shoe soles, the shoe product may be made entirely from a same or similar material, aid product may thereby be recycled as a whole, i.e., the concept of “whole-shoe recycling” may be realized without undergoing the decomposing and categorizing process. As a result, the shoe product may honor environmental-friendly appeal while meeting the product requirements.

However, in the existing art, the conventional polyamide has melting point that is too high for performing the foaming process smoothly. Moreover, the melt strength of the conventional polyamide is insufficient to fully support the integrity of the foam. Besides, the conventional polyamide is not suitable for foam molded product because the crystallinity of the material is too high due to the interaction of the hydrogen bonds therein. Therefore, in the existing art, chain extenders are added during the manufacturing process to improve the melt strength of the conventional polyamide. However, the issue of the unfavorably high melting point of the conventional polyamide has not been addressed yet.

In addition, the synthesis of the polyamide material is generally carried out by the polymerization between soft and hard segments. However, during the polymerization process, the ratio between the amino group and the carboxylic group in the reactants may be imbalanced due to imprecise weighing of the reactant, and monomers will evaporate under high reaction temperature, which also results in unbalanced amino/acid ratio. Thereby, the polymer produced therefrom will have uneven molecular weight and the increasing of the molecular weight will be limited.

Therefore, in order to address the disadvantages described above, there is a need to provide an improved polyamide foam molded body and a method for manufacturing the same.

### SUMMARY

In response to the above-referenced technical inadequacies, the present disclosure provides a polyamide foam molded body and the method for manufacturing the same which utilizes a polyamide terpolymer as the material for preparing the foam molded body, and the polyamide terpolymer is formed by a specific monomer composition and through a specific preparing process.

In one aspect, the present disclosure provides a method for manufacturing a polyamide foam molded body, including: performing polymerization with a monomer composition to form a polyamide terpolymer; mixing a supercritical carbon dioxide foaming agent and the polyamide terpolymer under a pressure to form a mixture; and releasing the pressure of the mixture to foam the polyamide terpolymer for forming the polyamide foam molded body. The monomer composition comprises 50 to 70 mole % of a caprolactam, 4 to 15 mole % of a polyetheramine, 4 to 15 mole % of a dicarboxylic acid and 15 to 30 mole % of a Nylon salt. The polyamide terpolymer includes a hard segment formed by the caprolactam, the dicarboxylic acid and the Nylon salt, and a soft segment formed by the polyetheramine.

In a preferred embodiment, the polyamide terpolymer has a melting point of 120 to 170° C., a glass transition temperature of −45 to 0° C. and a thermal decomposition temperature of 350 to 400° C.

In a preferred embodiment, the method further includes reacting the caprolactam with the Nylon salt to form the hard segment, and then reacting the hard segment with the soft segment to form the polyamide terpolymer.

In a preferred embodiment, the method further includes a step for preparing the Nylon salt, including mixing a diamine compound and a diacid compound in a solvent for forming the Nylon salt.

In a preferred embodiment, the supercritical carbon dioxide foaming agent is mixed with the polyamide terpolymer under a pressure of 80 to 150 bar and a temperature of 110 to 135° C.

In a preferred embodiment, the step of perfoiiiiing polymerization with a monomer composition to form the polyamide terpolymer includes: mixing the caprolactam, the dicarboxylic acid and the Nylon salt in a polymerization tank under nitrogen atmosphere; increasing the temperature of the polymerization tank to more than 200° C. and the pressure of the polymerization tank to at least 2 kg/cm² then stirring for at least 20 minutes, and thereafter, increasing the temperature of the polymerization tank to more than 220° C. then stirring for at least 2 hours; decreasing the pressure to normal pressure and feeding the polyetheramine to the polymerization tank; and increasing the temperature of the polymerization tank to more than 250° C. for at least 2 hours.

In a preferred embodiment, in the step of increasing the temperature of the polymerization tank to more than 200° C. and the pressure of the polymerization tank to at least 2 kg/cm² then stirring for at least 20 minutes, the stirring rate is 10 to 20 rpm.

In a preferred embodiment, in the step of increasing the temperature of the polymerization tank to more than 220° C. then stirring for at least 2 hours, the stirring rate is increased from about 20 rpm to about 55 rpm along with the increase of the temperature.

In a preferred embodiment, the method further includes, after increasing the temperature of the polymerization tank to more than 250° C. for at least 2 hours, terminating the reaction and performing unloading and cutting procedures under normal pressure and nitrogen atmosphere.

Another aspect of the present disclosure provides a polyamide foam molded body manufactured according to the method described above.

The method for manufacturing the polyamide foam molded body provided by the present disclosure uses a specific monomer composition for preparing a specific polyamide terpolymer, and further uses the specific polyamide terpolymer to perform the foaming process, thereby, a foam molded body with excellent properties may be obtained. Therefore, the polyamide foam molded body provided by the present disclosure may meet the requirements of the shoe-making industry while achieving the idea of whole-product recycling and whole-shoe recycling.

### BRIEF DESCRIPTION OF THE DRAWINGS

The present disclosure will become more fully understood from the following detailed description and accompanying drawings.

FIG. 1 shows the experiment result of the storage modulus of the polymers according to the embodiment of the present disclosure and the comparative example.

FIG. 2 shows the experiment result of the loss modulus of the polymers according to the embodiment of the present disclosure and the comparative example.

FIG. 3 shows the experiment result of the complex viscosity of the polymers according to the embodiment of the present disclosure and the comparative example.

FIG. 4 shows the experiment result of the loss tangent of the polymers according to the embodiment of the present disclosure and the comparative example.

### DETAILED DESCRIPTION

The present disclosure is described in more detail through the following examples that are intended to be illustrative only because numerous modifications and variations thereto will be apparent to those skilled in the art. Identical or similar numerals in the drawings indicate identical or similar components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles are used herein for the convenience of the reader, which shall not affect the scope of the present disclosure.

The terms used herein generally have their ordinary meanings in the art. In the case of conflict, the present document, including any definitions given herein, will prevail. The same item may be expressed in more than one way. Alternative language and synonyms may be adopted for any terms) discussed herein, and no specific significance is to be given to whether a term is elaborated on or discussed herein. A recital of one or more synonyms does not exclude the use of other synonyms. The use of examples anywhere in this specification, including examples of any terms, is illustrative only, and in no way limits the scope and meaning of the present disclosure or of any exemplified term. Likewise, the present disclosure is not limited to the various embodiments provided herein. Cardinal numbering terms such as “first”, “second” or “third” may be used to describe various components or the like, which are for distinguishing one component from another only, and are not intended to, nor should they be construed to impose any substantive limitations on the components or the like.

The embodiments of the present disclosure provide a method for manufacturing a polyamide foam molded body. Specifically, the method provided by the embodiments of the present disclosure includes synthesizing the material for the foaming process, i.e., a polyamide terpolymer, then using the polyamide terpolymer for performing the foaming process.

Therefore, in the method provided by the present disclosure, a monomer composition is used to perform the polymerization for forming the polyamide copolymer. The monomer composition includes monomer compounds for performing the polymerization, which are 50 to 70 mole % of a caprolactam (CPL), 4 to 15 mole % of a polyetheramine, 4 to 15 mole % of a dicarboxylic acid, and 15 to 30 mole % of a Nylon salt.

Specifically, the polyetheramine suitable for the embodiments of the present disclosure is preferably a diamine compound. In the embodiments of the present disclosure, the polyetheramine may have a molecular weight (Mw) ranging from 230 to 2003. For example, the polyetheramine may be a product of the HUNTSMAN company, such as the one under a model/trade name of D-230, D-400, D-2000, of JEFFAMINE® D series diamines, or ED-600, ED-900, ED-2003 of JEFFAMINE® ED series diamines, or RT-1000, RT-1400 of ELASTAMINE® Polyetheramines. In the above models, the Arabic numerals after the alphabets represent the molecular weights of the associated products, respectively.

On the other hand, the dicarboxylic acid may be an aliphatic dicarboxylic acid or an aromatic dicarboxylic acid (dicarboxylic acid with an aromatic ring). The examples of the aliphatic dicarboxylic acid include succinic acid, adipic acid, sebacic acid, dodecanedioic acid, tetradecanedioic acid, hexadecandioic acid, octadecandioic acid and octadecenedioic acid. The examples of the aromatic dicarboxylic acid include terephthalic acid, isophthalic acid, and 2,5-furandicarboxylic acid. For example, in the embodiments of the present disclosure, the products of CRODA company may be used as the dicarboxylic acid, such as the products with the trade names/models of Pripol™ 1009, Pripol™ 1006, Pripol™ 1025 F, Pripol™ 2030, Pripol™ 1012, Pripol™ 1013, Pripol™ 1017 or Pripol™ 1027.

The Nylon salt is selected from the group consisting of Nylon 46 salt, Nylon 410 salt, Nylon 4T salt, Nylon 412 salt, Nylon 54 salt, Nylon 510 salt, Nylon 512 salt, Nylon 64 salt, Nylon 66 salt, Nylon 610 salt, Nylon 612 salt, Nylon 614 salt, Nylon 618 salt, Nylon 6T salt, Nylon 9T salt, Nylon 912 salt, Nylon 1010 salt, Nylon 1012 salt, Nylon 1014 salt, Nylon 1018 salt, Nylon 10T salt, Nylon 1210 salt, Nylon 1212 salt and Nylon 12T salt.

In the embodiments of the present disclosure, the method may further include a step of preparing the Nylon salt including: mixing a diamine compound and a dicarboxylic acid compound in a solvent. The diamine compound may be butylenediamine, pentylenediamine, hexamethylenediamine, nonanediamine, decanediamine or dodecanediamine; the dicarboxylic acid compound may be succinic acid, adipic acid, sebacic acid, dodecanedioic acid, tetradecanedioic acid, hexadecandioic acid, octadecanedioic acid, octadecenedioic acid or terephthalic acid. The compounds and the parameters of the preparation process may be duly selected by those skilled in the art according to their knowledge and needs. For example, in the embodiments of the present disclosure, the water solution of Nylon salt may be formed and then the Nylon salt may be obtained through a filtering process. Specifically, in order to synthesize the Nylon salt, in the embodiments of the present disclosure, the following synthesis steps may be carried out: dissolving a diamine and a dicarboxylic acid with the same mole ratio in a neutral solvent and mixing the compounds through stirring; stop stirring after a certain time and cooling the product to room temperature; and obtaining the Nylon salt after the salt crystals are precipitated.

It should be noted that during the synthesis of the polyamide terpolymer of the present disclosure, if the monomer compounds in the monomer composition are directly subjected to the polymerization process, the properties of the polyamide terpolymer prepared therefrom may not meet the purpose of the present disclosure. Specifically, the ratio between the acid moieties and the amine moieties in the Nylon material is strictly required, and hence, if the diamine and the dicarboxylic acid are used as monomer components to perform the polymerization reaction directly rather than forming the Nylon salt as a monomer component for the polymerization process in advance, a Nylon segment with the acid : amine ratio of 1:1 is hard to obtain. Therefore, in the embodiments of the present disclosure, the diamine and the dicarboxylic acid are reacted to form an uncharged Nylon salt and then the Nylon salt is used as a monomer component to carry out the polymerization for synthesizing the desired polyamide terpolymer.

In addition, in the present disclosure, a polyamide copolymer with hard segments and soft segments is formed by using the monomers described above and through the polymerization with specific order and steps described above. Therefore, in the embodiments of the present disclosure, the prepared polyamide copolymer is a polyamide terpolymer having a structure of “Polyamide-co-polyamide salt-co-polyetheramine”. In the above structure, the polyamide and the polyamide salt together form the hard segment of the copolymer, while the polyetheramine fou its the soft segment of the copolymer. Thereby, the method according to the embodiments of the present disclosure may further include a step of reacting the caprolactam and the Nylon salt to form the hard segment, then forming the polyamide terpolymer by reacting the hard segment and the soft segment consisted of the polyetheramine.

In other words, in a preferred embodiment of the present disclosure, the hard segment in the polyamide terpolymer is formed first, i.e., a pre-polymerization is carried out to form the hard segment, for adjusting and establishing the crystallization properties, such as melting point, of the polyamide terpolymer formed thereafter. Next, the remaining monomer components are reacted with the prepolymer consisted of the hard segments to form a polyamide terpolymer comprising the hard segments and the soft segments. As a result, the polyamide terpolymer formed therefrom is a block copolymer and the melting point of the polyamide terpolymer is determined by the hard segment without being affected by the soft segment formed thereafter. Compared to a random polymer which is often formed by using all the monomer components at once to perform the polymerization process, in the preferred embodiment according to the present disclosure, the desired properties, for example, the melting point, of the polyamide terpolymer may be ensured, and the glass transition temperature and flexibility, such as the tensile properties, of the polyamide terpolymer may be adjusted by the parameters (such as the length of the chain) of the soft segment. Thereby, in the preferred embodiment according to the present disclosure, the properties of the polyamide terpolymer, such as the melting point and the tensile property, may be precisely controlled through the manufacturing process.

Specifically, in order to prepare the polyamide terpolymer, the embodiments of the present disclosure may include the following steps: mixing the caprolactam, the dicarboxylic acid and the Nylon salt in a polymerization tank under nitrogen atmosphere; increasing the temperature of the polymerization tank to more than 200° C. and the pressure of the polymerization tank to at least 2 kg/cm² then stirring for at least 20 minutes, and then increasing the temperature of the polymerization tank to more than 220° C. then stirring for at least 2 hours; decreasing the pressure to room pressure and feeding the polyetheramine to the polymerization tank; and increasing the temperature of the polymerization tank to more than 250° C. for at least 2 hours. As shown in the manufacturing process above, preferably, the embodiments of the present disclosure include forming a prepolymer by the caprolactam, the dicarboxylic acid and the Nylon salt, and then adding the polyetheramine to form the copolymer, i.e., the polyamide terpolymer.

Specifically, in the embodiments of the present disclosure, in the step of increasing the temperature of the polymerization tank to more than 200° C. and the pressure of the polymerization tank to at least 2 kg/cm² then stirring for at least 20 minutes, the stirring rate may, for example, range from 10 to 20 rpm. In the step of increasing the temperature of the polymerization tank to more than 220° C. then stirring for at least 2 hours, the stirring rate may be increased from about 20 rpm to about 55 rpm along with the increase of the temperature. In addition, after increasing the temperature of the polymerization tank to more than 250° C. for at least 2 hours, the reaction may be terminated and the unloading and cutting procedures are performed under nounal pressure and nitrogen atmosphere. The method provided by the embodiments of the present disclosure will be exemplified through specific examples below.

Based on the synthesis steps described above, the polyamide terpolymer in the embodiments of the present disclosure may possess a melting point ranging from 120 to 170° C., a glass transition temperature ranging from −45 to 0° C., and a thermal decomposition temperature ranging from 350 to 400° C. Preferably, the polyamide terpolymer in the preferred embodiments of the present disclosure may possess a melting point of 120 to 140° C.

Next, regarding the foaming process, in the embodiments of the present disclosure, the process for foaming the prepared polyamide terpolymer includes mixing a supercritical carbon dioxide foaming agent and the polyamide terpolymer under a pressure to form a mixture. In a preferred embodiment, the supercritical carbon dioxide foaming agent is mixed with the polyamide terpolymer under a pressure ranging from 80 to 150 bar and a temperature ranging from 110 to 135° C. Next, the pressure of the mixture is released to facilitate the foaming of the polyamide terpolymer, which is then used to form the polyamide foam molded body. In the embodiments of the present disclosure, the foam expansion ratio of the polyamide terpolymer may be ranging from 4 to 21 times. It should be noted that the embodiments of the present disclosure adopt a low temperature foaming process while a high foaming ratio may still be achieved.

In addition to the method for manufacturing a polyamide foam molded body, the embodiments of the present disclosure further provide a polyamide foam molded body manufactured by the method described above.

The method for manufacturing a polyamide foam molded body provided by the present disclosure is to be exemplified hereafter by specific synthesis examples, embodiments and comparative examples.

### Synthesis Example: Synthesis of the Polyamide Terpolymer

First, the Nylon salt for synthesizing the polyamide terpolymer is prepared. However, it should be noted that in the present disclosure, a commercially obtainable Nylon salt may be used as the reactant for synthesizing the polyamide terpolymer. Specifically, hexamethylenediamine (HMDA) is dissolved in a deionized water and then is slowly added to a deionized water solution with dodecanedioic acid (DA) having a solid content of 50% and equipped with a mechanical stiffing device. The solution is stirred under room temperature for 2 hours. Along with the neutralization reaction, the reaction temperature increases and the dodecanedioic acid is dissolved gradually and is formed in a uniform phase. After stirring for 2 hours, stop stirring and cool the product to room temperature. Crystalized salt is then precipitated, and a white crystal is obtained through filtration. The crystal is washed by ethanol thoroughly and placed in a vacuum oven for drying under 80′ C for a day, thereby a polyamide 612 salt in the form of a white crystal is obtained.

Next, the polyamide terpolymer to be used in the present disclosure is prepared. 200 grams (1.7675 moles, 51.17 mole %) of caprolactam (CAS. No. 105-60-2, purchased from China Petrochemical Development Corporation), 107 grams (0.4646 moles, 13.45 mole %) of dodecanedioic acid (CAS No. 693-23-2, purchased from GO YEN CHEMICAL INDUSTRIAL CO LTD) and 262 grams (0.7575 moles, 21.93 mole %) of 612 Nylon salt are added to a 5 liters steel polymerization tank under nitrogen atmosphere. While gradually increasing the stirring rate, the temperature of the polymerization tank is increased to more than 200° C. and the pressure of the polymerization tank is increased to 2 kg/cm^{2 ,} and the stirring rate is ranging from 10 to 20 rpm. After stirring for 20 minutes, the temperature is increased to 220° C., and the stirring rate is increased to 50 rpm for 2 hours. After 2 hours, under nitrogen flow, the pressure in the polymerization tank is slowly decreased to normal pressure, and 465 grams (0.4646 moles, 13.45 mole %) of polyetheramine monomer (RT-1000, purchased from HUNTSMAN) to be served as the soft segment is added to the polymerization tank in a 2^{nd} feed manner. After the polyetheramine monomer is completely added into the high-pressure polymerization tank, the temperature of the polymerization tank is increased to 250° C., and the reaction is carried out for 3 hours. After a preferred toque for unloading is reached, the reaction is terminated and the unloading and cutting procedures are performed under normal pressure and nitrogen atmosphere.

### Comparative Synthetic Example

Compared to the synthetic example, in the comparative synthetic example, the monomer components are subject to the polymerization directly without forming the Nylon salt to be used as one of the monomer components in advance.

In the comparative synthetic example, 200 grams (1.7675 moles, 41.96 mole %) of caprolactam (CAS. No. 105-60-2, purchased from China Petrochemical Development Corporation), 281 grams (1.2221 moles, 29.02 mole %) of dodecanedioic acid (CAS No. 693-23-2, purchased from GO YEN CHEMICAL INDUSTRIAL, CO LTD) and 88 grams (0.7575 moles, 17.99 mole %) of hexamethylenediamine (CAS No. 124-04-9, purchased from ECHO CHEMICAL CO., LTD.) are added to a 5 liters steel polymerization tank under nitrogen atmosphere. While gradually increases the stirring rate, the temperature of the polymerization tank is increased to more than 200° C. and the pressure of the polymerization tank is increased to 2 kg/dcm², and the stirring rate is ranging from 10 to 20 rpm. After stirring for 20 minutes, the temperature is increased to 220° C., and the stirring rate is increased to 50 rpm for 2 hours. After 2 hours, under nitrogen flow, the pressure in the polymerization tank is slowly decreased to normal pressure, and 465 grams (0.4646 moles, 11.03 mole %) of polyetheramine monomer (RT-1000, purchased from HUNTSMAN) to be served as the soft segment is added to the polymerization tank in a 2nd feed manner. After the polyetheramine monomer is completely added into the high-pressure polymerization tank, the temperature of the polymerization tank is increased to 250° C., and the reaction is carried out for 4 hours. After 4 hours, the reaction torque of the reaction of the polymer does not significantly increase, and the unloading procedure is performed under normal pressure and in a nitrogen atmosphere. The unloaded product is unable to perform the stretching and cutting process. As a result, the polymerization process cannot be performed successfully to form a polymer product.

Accordingly, compared to the process used in the comparative synthetic example, the two-step polymerization process provided by the present disclosure as shown in the above synthesis example, may obtain the desired polyamide terpolymer for founing a foam molded body successfully.

### Preparation Example and Comparative Example: Preparation of the Foaming Material

Reference is made to Table 1 and Table 2 as shown below. Examples 1 to 8 are the polyamide copolymers prepared using the monomer components according to the synthetic example of the present disclosure. Comparative examples 1 to 3 are the existed polyamide copolymer products (commercially available Nylon 6 and Pebax series products). The ratios of the monomer components of examples 1 to 8 are detailed in Table 1, and the results of the measured physical properties of the polymers in examples 1 to 8 and comparative examples 1 to 3 are shown in Table 2.

In Table 2, the date of the thermal decomposition temperature (Td) is obtained by a theimogravimetric analyzer (TGA). The data of the glass transition temperature (Tg) is obtained by a dynamic mechanical analyzer (DMA).

TABLE 1

| | | | | Nylon | hexanedioic | Nylon |
|---|---|---|---|---|---|---|
| | caprolactam | polyetheramine | dodecanedioic acid | 612 salt | acid | 66 salt |
| Example 1 | 66.71% | 5.53% | 5.53% | 22.23% | — | — |
| Example 2 | 61.84% | 5.83% | 5.83% | 26.50% | — | — |
| Example 3 | 61.92% | 8.72% | 8.72% | 20.64% | — | — |
| Example 4 | 57.10% | 9.22% | 9.22% | 24.46% | — | — |
| Example 5 | 55.67% | 12.88% | 12.88% | 18.57% | — | — |
| Example 6 | 51.17% | 13.45% | 13.45% | 21.93% | — | — |
| Example 7 | 67.74% | 4.84% | — | — | 4.84% | 22.58% |
| Example 8 | 63.79% | 7.47% | — | — | 7.47% | 21.27% |

TABLE 2

| | Td(5%)(° C.) | Tm(° C.) | Tc(° C.) | ΔHm(J/g) | Tg(° C.) |
|---|---|---|---|---|---|
| Example 1 | 375.1 | 134.2 | 54.1** | 19.3 | −8.2 |
| Example 2 | 374.4 | 134.1 | 53.2** | 18.3 | −9.3 |
| Example 3 | 373.4 | 135.0 | 27.6** | 20.2 | −17.6 |
| Example 4 | 372.1 | 134.7 | 25.7** | 18.7 | −18.5 |
| Example 5 | 368.4 | 135.3 | 83.4* | 22.1 | −39.7 |
| Example 6 | 367.7 | 135.2 | 83.2* | 19.5 | −40.2 |
| Example 7 | 373.6 | 166.7 | 98.7* | 13.4 | −3.2 |
| Example 8 | 370.2 | 167.9 | 95.4* | 14.6 | −11.3 |
| Comparative | 386.6 | 220.8 | 172.2* | 51.2 | 54.2 |
| example 1 (PA6) | | | | | |
| comparative | 378.6 | 143.0 | 68.8* | 32.2 | −39.0 |
| example 2 | | | | | |
| (Pebax3533) | | | | | |
| comparative | 382.4 | 173.5 | 35.9* | 37.6 | 61.8 |
| example 3 | | | | | |
| (Pebax7233) | | | | | |

*Said temperature represents the crystallization temperature of the melted polymer during the cooling process.
**Said temperature represents the crystallization temperature observed during a second run of temperature increase upon the cooled solid polymer, because during the cooling process of the melted polymer, there is no crystallization temperature to be observed.

According to the experiment result shown in Table 2, the polyamide terpolymer according to the present disclosure possesses a melting point ranging from 120 to 170° C., a glass transition temperature ranging from −40 to 0° C. and a thermal decomposition temperature ranging from 350 to 400° C. Moreover, as a preferred embodiment, the polyamide terpolymer of examples 1 to 6 possess melting points ranging from 120 to 140° C. Although the polymers of comparative examples 1 and 3 also possess thermal decomposition temperatures ranging from 350 to 400° C., these polymers' melting points are all higher than 170° C. Among the polymers of Comparative examples 1 to 3, for example, the conventional Nylon 6 material used in the comparative example 1 is not suitable for supercritical foaming process, and although comparative examples 2 and 3 are the elastomers prepared by the well-known supercritical foaming process, the results of rheology experiment and actual foaming experiment thereof are still not as satisfied as the polyamide terpolymer prepared by the embodiments of the present disclosure.

Besides, the polymers of the comparative examples 1 and 3 further possess a glass transition temperature that is too high. Specifically, if the glass transition temperature of a polymer material is low, the product manufactured therefrom is assumed to have great flexibility like rubber, i.e., being soft and elastic under room temperature. Because an elastomer is the intended product that the present disclosure is aimed to prepare, the elastomer is preferred to be soft and elastic, and the lower the glass transition temperature is, the larger the applicable range of the preferred properties may be covered. Therefore, the polymers according to the embodiments of the present disclosure exhibit better properties which are more preferred to an elastomer system when compared to that of the polymers according to comparative examples 1 and 3.

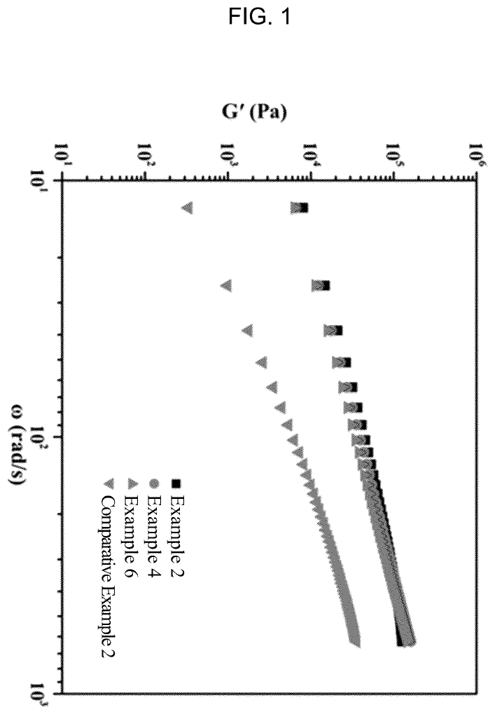

Next, based on various studies, the rheology behavior of a polymer is critical during the foaming process, i.e., the preferred conditions for performing melted foaming include appropriate viscosity, good elastic and high melt strength. In order to confirm the relationship between the rheology property and the effect of the melt foaming process using supercritical carbon diode, the inventors of the present disclosure compare Examples 2, 4 and 6 with Comparative Example 2 through a rheology analysis. FIG. 1 of the present disclosure shows (a) storage modulus G′, (b) loss modulus G″, (c) complex viscosity η* and (d) loss tangent tan δ (or referred to as medium loss tangent). The data are obtained by an analysis carried out by a rheometer instrument.

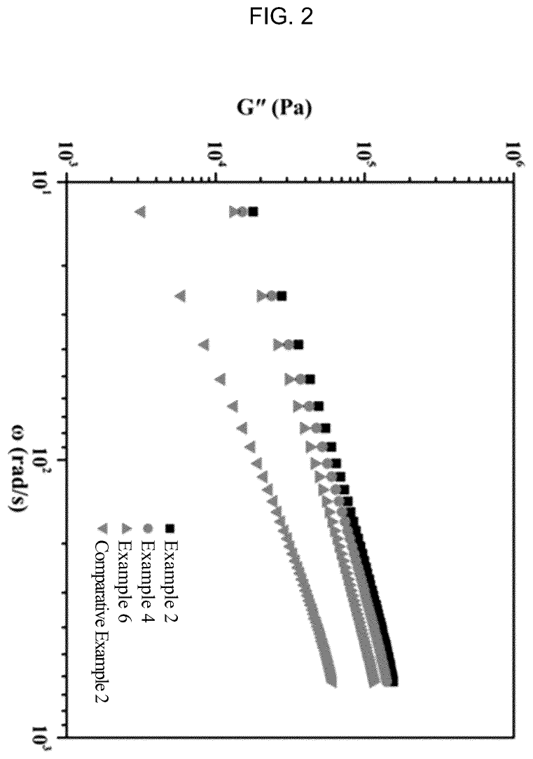

Reference is made to FIGS. 1 to 4. FIG. 1 and FIG. 2 are the experiment results of the storage modulus (viscosity) and loss modulus (elastic) of the polymers according to the examples of the present disclosure and the comparative example, respectively. As shown in FIG. 1 and FIG. 2, as the frequency increases gradually, both storage modulus and loss modulus increase gradually as well; however, the increase rate is low. Especially, when compared to the Comparative Example 2, Examples 2, 4 and 6 according to the present disclosure exhibit significantly better viscosity and elastic properties.

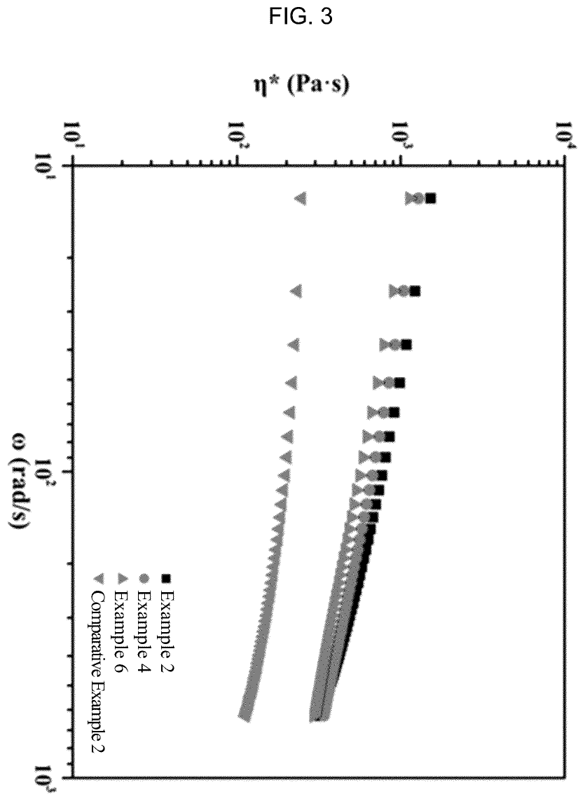

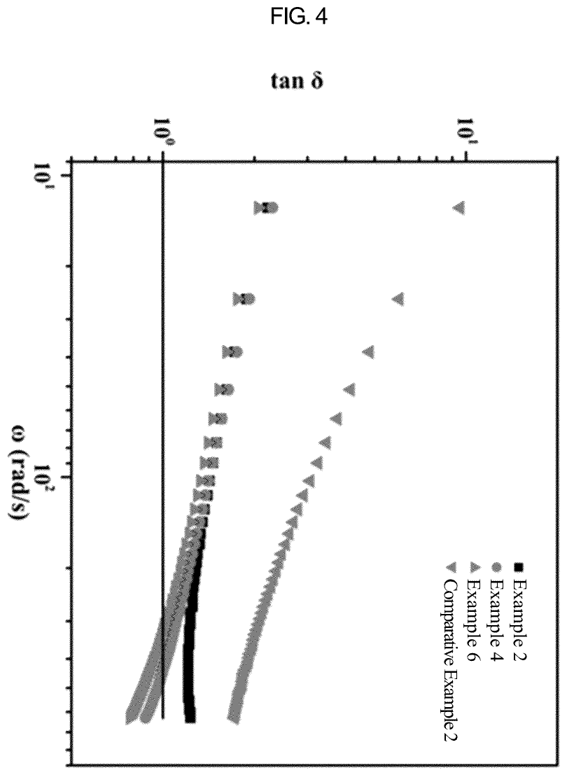

FIG. 3 shows the experiment result of the multiple viscosity of the polymer according to the examples of the present disclosure and the comparative example. As shown in FIG. 3, as the frequency increases, the examples and the comparative example each shows the phenomenon of shear thinning. When compared to Comparative Example 2, the Examples 2, 4 and 6 exhibit better complex viscosity. FIG. 4 shows the experiment result of the loss tangent (tan δ) of the polymers according to the present disclosure and the comparative example. Specifically, the experiment result of the loss tangent (tan 6) obtained by the rheology experiment may be used for analysis. As shown in FIG. 4, the loss tangents of the examples according to the present disclosure are lower than that of the comparative example, and the loss tangents under high frequency are less than 1, i.e., G′ is larger than G″, which represents that under high frequency, the elastic property is dominant among the viscosity-elastic properties. The smaller the tan d is, the higher rate the close foam appears. When G′ is relatively larger than G″, indicating that the proportion of elasticity dominant in the viscoelastic performance of the material is greater. Therefore, during the foaming process, the polymer material possesses sufficient melt strength to support the foamed cells, avoiding rupture or collapse in the process and eventually forming closed-cell cells. In other words, this rheological behavior may maintain cell growth and prevent cell from rupture during the foaming process.

Thereby, when compared to the polymer of the comparative example, the polymers according to the present disclosure are more preferred for the foaming process.

Next, the polyamide copolymer prepared in the example and the comparative example are subject to the foaming process. In Table 3, the composition of Example 6 is used to prepare the polyamide terpolymer, and the material of Comparative Example 2 is used as the control group. The foaming process includes immersing the polyamide terpolymer in the liquid nitrogen for 2 minutes, then cutting the materials into rectangular samples with proper size and drying in a hot air oven for 1 day. Thereafter, the samples are placed in a high-pressure syringe pump in a vessel coexisted with supercritical carbon dioxide. Under the pressure and temperature listed in Table 3, the supercritical carbon dioxide is incorporated into the sample, i.e., the polyamide copolymer, and the polyamide copolymer is immersed in the supercritical carbon dioxide for 4 hours. The sample is then cooled and solidified; the pressure is released for forming the polyamide foam molded body. The foam expansion ratio of the samples according to Example 6 and Comparative Example 2 under different temperatures and pressures are shown in Table 3. The foam expansion ratios of the samples are calculated by obtaining the specific weight of the samples before and after the foaming process using electric scale and calculating through the formula 1 below:

$$ρ = \frac{Wa}{Wa - Wl} ρ l \qquad formula 1$$

Wherein Wa is the weight of the material measured in the air, Wl is the weight of the material measured in water, and pl is the specific weight of water.

TABLE 3

| | 110° C./150 bar | 120° C./150 bar | 125° C./150 bar | 135° C./150 bar | 125° C./80 bar | 135° C./80 bar |
|---|---|---|---|---|---|---|
| Example 6 | 4.1 | 5.2 | 9.7 | 21 | 7.9 | 17 |
| Comparative | not | 2.4 | 4.2 | 5.7 | 3.2 | 5.2 |
| Example 2 | foaming | | | | | |

According to Table 3, the polyamide terpolymer of Example 6 according to the present disclosure demonstrates excellent foaming properties under 125° C/150 bar, 135° C/150 bar and 135° C/80 bar. In contrast thereto, although the material of Comparative Example 2 may form a foam molded body under the condition of higher than 120° C., the foam expansion ratios thereof are lower than that of the Example 6.

Subsequently, the polyamide terpolymers prepared in Examples 2, 4 and 7 are subject to the foaming process. The foaming process is the same as Example 6 and Comparative Example 2 described above. The condition of the foaming process and the foam expansion ratios of the polyamide terpolymer are shown in Table 4 below.

TABLE 4

| | 125° C./150 bar | 135° C./150 bar | 155° C./150 bar | 165° C./150 bar |
|---|---|---|---|---|
| Example 2 | 6.8 | 14 | X | X |
| Example 4 | 7.4 | 16 | X | X |
| Example 7 | X | X | 7.3 | 15 |

*X represents that the foaming process is not performed under such condition.

In summary, based on the experiment results of the examples and the comparative example, the method for manufacturing polyamide foam molded body and the polyamide foam molded body manufactured therefrom provided by the embodiments of the present disclosure exhibit extraordinary foaming effect, i.e., possess excellent foam expansion ratio under various temperatures and pressures, and based on the selection and control of the formulations for forming the polyamide terpolymer, the polyamide terpolymer used as a foaming material demonstrate great physical properties and is preferred for producing the foam molded body which meets environmental friendly preference.

The above embodiments were chosen and described in order to explain the principles of the disclosure and their practical application, so as to enable others skilled in the art to utilize the disclosure in various embodiments and with various modifications as are suited to the particular use contemplated. Alternative embodiments will be apparent to those skilled in the art to which the present disclosure pertains without departing from its spirit and scope.

What is claimed is:

1. A method for manufacturing a polyamide foam molded body, including:
performing polymerization with a monomer composition to form a polyamide terpolymer;
mixing a supercritical carbon dioxide foaming agent and the polyamide terpolymer under a pressure to form a mixture; and
releasing the pressure of the mixture such that the foaming of the polyamide terpolymer is performed, so as to form the polyamide foam molded body;
wherein the monomer composition comprises 50 to 70 mole % of a caprolactam, 4 to 15 mole % of a polyetheramine, 4 to 15 mole % of a dicarboxylic acid and 15 to 30 mole % of a Nylon salt;
wherein the polyamide terpolymer includes a hard segment and a soft segment, the hard segment includes a polyamide block and a polyamide salt , and the soft segment is composed of the polyetheramine;
wherein the polyamide terpolymer is formed by reacting the caprolactam and the Nylon salt to form the hard segment, and then reacting the hard segment with the soft segment.

2. The method according to claim 1, wherein the polyamide terpolymer possesses a melting point ranging from 120 to 170° C., a glass transition temperature ranging from −45 to 0° C. and a thermal decomposition temperature ranging from 350 to 400° C.

3. The method according to claim 1, further including a step for preparing the Nylon salt, including mixing a diamine compound and a diacid compound in a solvent to form the Nylon salt.

4. The method according to claim 1, wherein the supercritical carbon dioxide foaming agent is mixed with the polyamide terpolymer under a pressure of 80 to 150 bar and a temperature of 110 to 135° C.

5. The method according to claim 1, wherein the step of performing polymerization with the monomer composition to form the polyamide terpolymer includes:
mixing the caprolactam, the dicarboxylic acid and the Nylon salt in a polymerization tank under nitrogen atmosphere;
increasing a temperature of the polymerization tank to more than 200° C. and a pressure of the polymerization tank to at least 2 kg/cm² then stirring for at least 20 minutes, and then increasing the temperature of the polymerization tank to more than 220° C. then stirring for at least 2 hours;
decreasing the pressure to normal pressure and feeding the polyetheramine to the polymerization tank; and
increasing the temperature of the polymerization tank to more than 250° C. for at least 2 hours.

6. The method according to claim 5, wherein in the step of increasing the temperature of the polymerization tank to more than 200° C. and the pressure of the polymerization tank to at least 2 kg/cm² then stirring for at least 20 minutes, the stirring rate is ranging from 10 to 20 rpm.

7. The method according to claim 5, wherein in the step of increasing the temperature of the polymerization tank to more than 220° C. then stirring for at least 2 hours, the stirring rate is increased from about 20 rpm to about 55 rpm along with the increase of the temperature.

8. The method according to claim 5, further including, after increasing the temperature of the polymerization tank to more than 250° C. for at least 2 hours, terminating the polymerization and performing unloading and cutting procedures under nolinal pressure and nitrogen atmosphere.

9. A polyamide foam molded body manufactured according to the method of any one of claims 1 to 8.
